(19) United States
(12) Patent Application Publication
(10) Pub. No.: US 2006/0171549 A1
(43) Pub. Date: Aug. 3, 2006

(54) Hearing aid eartip coupler system and method

(76) Inventor: David William Holmes, Colleyville, TX (US)

Correspondence Address: KEVIN MARK KLUGHART, 2516 LILLIAN MILLER PARKWAY, SUITE 115, DENTON, TX, 76210-7205, US

(21) Appl. No.: 11/049,495

(22) Filed: Feb. 2, 2005

(51) Int. Cl. H04R 25/00

(52) U.S. Cl. 381/330; 181/129; 381/328

(57) ABSTRACT

A hearing aid eartip coupler system and method is disclosed which permits interfacing existing hearing aids with a variety of high performance hearing aid eartips for use by patients with mild to moderate hearing loss. Conventional hearing aid earmolds connected to over-the-ear hearing aids suffer from a high degree of feedback and “tunnel effect” associated with blockage of the ear canal by the earmold, as well as unsightly large eartip tubes. The present invention permits cost-effective over-the-ear hearing aids to be retrofitted with a variety of vented hearing aid eartips and smaller eartip tubes to improve the performance and appearance of the overall hearing aid system for use with patients having mild to moderate hearing loss. Additionally, the use of the disclosed coupler system and method permits replacement and/or resizing of the hearing aid eartip should this portion of the system be deemed unsuitable for use by the patient.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention relates generally to the hearing aid industry, and specifically to situations where existing behind-the-ear hearing aids are to be retrofitted with improved hearing aid eartips.

The motivation behind the present invention relates to deficiencies in current behind-the-ear hearing aid systems, specifically relating to persons having mild to moderate hearing loss. Statistics indicate that 42% of hearing impaired patients experience mild to moderate hearing loss. Existing solutions to aid these patients generally involve the use of either an expensive high performance hearing aid system (costing approximately USD$2000-USD$3000) or alternatively an inexpensive low performance behind-the-ear hearing aid system (costing approximately USD$300). Unfortunately, the performance of existing cost-effective behind-the-ear hearing aid systems suffers due to the use of large connecting tubing and ear molds which are both unfashionable and reduce the performance of the system. The present invention solves these problems and permits a wide application of inexpensive behind-the-ear hearing aids to the 42% of the hearing impaired population with mild to moderate hearing loss.

### DESCRIPTION OF THE PRIOR ART (0100)

The prior art is generally illustrated in FIG. 1 (0100), which illustrates a typical behind-the-ear hearing aid configuration. Referencing FIG. 1 (0100), the behind-the-ear hearing aid is worn over the ear by the patient. This typical configuration incorporates a battery drawer and ON/OFF switch (0101), function switch (0102), volume control (0103), microphone opening (0104), earhook (0105) (also referred to as a sound hook in some configurations), eartip tube (0106), earmold assembly (0107) further comprising a sound outlet (0108) which transports amplified ambient sound to the patient's ear canal. The configuration in FIG. 1 (0100) illustrates a typical behind-the-ear hearing aid configuration, with some models possibly either incorporating other features or possibly omitting features illustrated in the example of FIG. 1 (0100).

As a general observation, typical behind-the-ear hearing aid system as illustrated in FIG. 1 (0100) are all characterized by a hearing aid earhook (0105), eartip tube (0106), and hearing aid earmold (0107). In these configurations the hearing aid eartip tube (0106) is specifically configured to mate the output of the hearing aid earhook (0105) to the hearing aid earmold (0107). Generally, the hearing aid eartip tube (0106) inside diameter remains identical between the hearing aid earhook (0105) and the hearing aid earmold (0107).

The typical behind-the-ear hearing aid as illustrated in FIG. 1 (0100) also incorporates eartube interface (0109) at the distal end of the earhook (0105), also referred to as an earhook output connection port. This interface mates specifically with the eartip tube (0106) for a particular earmold (0107) assembly and is generally not interchangeable with other eartips. This configuration of behind-the-ear hearing aid has become dominant in many applications, and represents a baseline configuration for many inexpensive hearing aid configurations.

A major disadvantage of the existing behind-the-ear hearing aid configurations as illustrated in FIG. 1 is the fact that while the hearing aid body (0110) may have technical performance suitable for a wide variety of individuals with mild to moderate hearing loss, the hearing aid earmold (0107) associated with many behind-the-ear hearing aids is unsuitable for many of these patients. The wide variety of patient ear canal configurations precludes the formation of individual eartip forms for each patient, as the eartip tube (0106) varies significantly between most behind-the-ear hearing aids. Furthermore, earmolds as illustrated generally in FIG. 1 (0107) often occlude the ear canal, resulting in poor patient performance. As a result, existing users of behind-the-ear hearing aids are significantly limited as to their options as to customized or high performance hearing aid eartips.

One significant disadvantage associated with the behind-the-ear hearing aids illustrated in FIG. 1 is the relationship between hearing aid gain and the potential for feedback in the hearing aid system. Patients with moderate to high hearing aid loss require large volume gain in the hearing aid system. This limits the types of eartip configurations to tight or form-fitting earmolds (0107). The reason for this is that a high gain in the hearing aid system necessitates that little sound reflect back from the ear canal. This requires that the eartip/earmold be relatively tight fitting with little venting of the ear canal. This restriction results in a “tunnel” effect with respect to the sound quality experienced by the patient. Additionally, the requirement for high gain in these circumstances requires eartip tubes with large diameters to accommodate the sound transport requirements in these situations. These large diameter eartip tubes tend to be unattractive and therefore shunned by patients.

The prior art has yet to address the above detailed deficiencies in existing behind-the-ear hearing aid configurations.

### OBJECTIVES OF THE INVENTION

Accordingly, the objectives of the present invention are (among others) to circumvent the deficiencies in the prior art and affect the following objectives:

(1) Permit existing behind-the-ear hearing aids to be retrofitted with a variety of hearing aid eartips.

(2) Permit an existing behind-the-ear hearing aid to be repaired via the use of a new hearing aid eartip.

(3) Permit the use of a less expensive hearing aid body with a variety of high performance hearing aid eartips, thus improving the performance of an existing behind-the-ear hearing aid system by replacement of the existing hearing aid eartip.

(4) Permit patients to obtain customized hearing aid eartips for use with behind-the-ear hearing aid systems which were not specifically designed for patient customization.

(5) Permit a wide variety of patients with mild to moderate hearing loss to afford an economic and aesthetically pleasing hearing aid with sound characteristics and performance comparable to that of expensive hearing aid systems.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

### Exemplary Prior Art Earmold (0100)

As illustrated generally in FIG. 1 (0100), the prior art teaches the use of earmold assemblies (0107) in conjunction with behind-the-ear hearing aids. The contrast between this configuration (0107) and the non-occluding eartip assembly (0205) results in a significantly more aesthetically pleasing form factor for the patient using the present invention as compared to the prior art.

Additionally, earmold configurations as illustrated in FIG. 1 (0107) tend to occlude the ear canal, resulting in a “tunneling” effect on perceived sound from the hearing aid amplifier. The use of non-occluding eartip assemblies (0205) thus also results in a better performance of the overall hearing aid system for the patient. This configuration is most suitable for patients with mild to moderate hearing loss.

### Comparison to Prior Art Earmolds (0100)

In contrast with the prior art, patients with mild to moderate hearing loss can benefit from eartips that do not fully occlude the ear canal, thus preventing the “tunnel” effect normally associated with traditional earmolds. These eartips are not only smaller than traditional earmolds, but when inserted in the patient ear canal are not as visible (and therefore more visually appealing) than traditional earmolds (0107).

Additionally, patients with mild to moderate hearing loss require sound volume gain significantly lower than patients with more profound hearing loss, thus permitting the use of eartip tubes which are significantly smaller in diameter than traditional behind-the-ear hearing aids. This reduction in eartip tube size and associated use of non-occluding eartip tubes (instead of bulkier earmolds) results in a more aesthetically appealing hearing aid system than presented by the prior art. However, despite these potential benefits, the prior art has not taught the use of modified behind-the-ear hearing aids for patients with mild to moderate hearing loss. A specific hurdle to this modification has been the variation in eartip tube interfaces (0109) (earhook output connection port) associated with the earhooks (0105) of most behind-the-ear hearing aids (0100). The prior art has not addressed how this interface can be mated with any number of eartip tubes currently available on the market.

### General Construction (0200, 0300, 0400)

The present invention system is generally illustrated in FIGS. 2-9. Referring to FIG. 2 (0200), the general concept behind the present invention is to mate an existing behind-the-ear hearing aid (0201) having an earhook (0202) to an eartip tube (0204) connected to an eartip (0205). The present invention incorporates an interface coupler (0203) that permits adapting the earhook (0202) end outer diameter with a variety of eartip tube (0204) outer diameters.

FIG. 2 (0200) illustrates the present invention as applied to a patient's ear (0210). FIG. 3 (0300) illustrates the present invention apart from the patient. FIG. 4 (0400) illustrates an assembly drawing of the present invention which shows how the present invention permits using the interface coupler (0203) to mate a conventional hearing aid body (0201) and associated hearing aid earhook (0202) to a wide variety of hearing aid eartip tubes (0204) and eartips (0205).

### BRIEF DESCRIPTION OF THE DRAWINGS

For a fuller understanding of the advantages provided by the invention, reference should be made to the following detailed description together with the accompanying drawings wherein:

FIG. 1 illustrates a prior art behind-the-ear hearing aid;

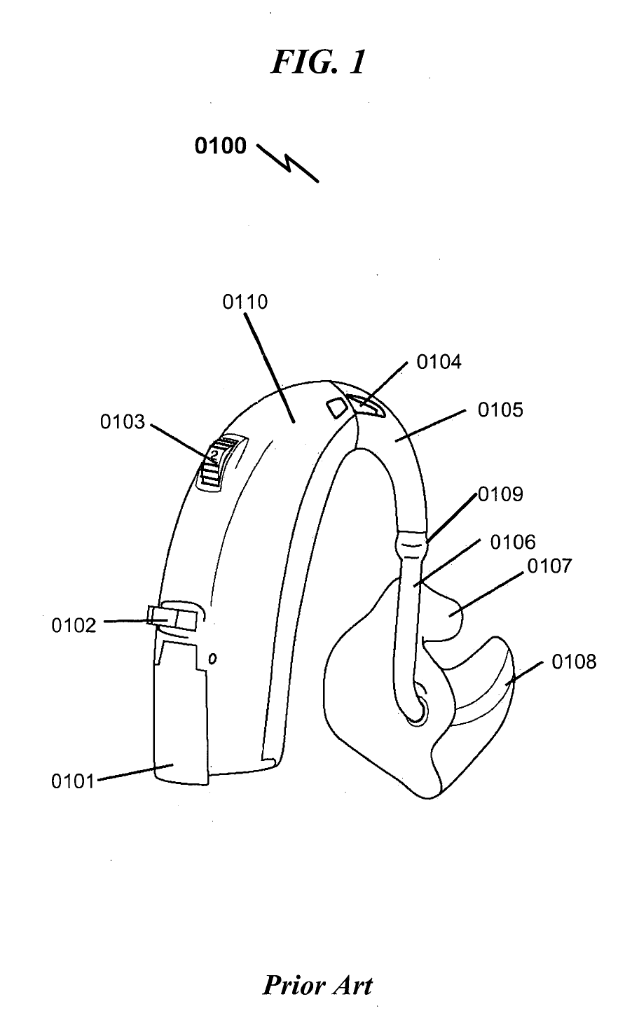

FIG. 2 illustrates an exemplary embodiment of the present invention as applied to a behind-the-ear hearing aid system in use by a patient;

FIG. 3 illustrates an exemplary embodiment of the present invention as applied to a behind-the-ear hearing aid system;

FIG. 4 illustrates an assembly detail of an exemplary embodiment of the present invention as applied to a behind-the-ear hearing aid system;

FIG. 5 illustrates an exemplary embodiment of the present invention detailing the interface between an over-the-ear hearing aid and hearing aid eartip;

FIG. 6 illustrates a side view detail of an exemplary embodiment of the present invention eartip coupler;

FIG. 7 illustrates top perspective view detail of an exemplary embodiment of the present invention eartip coupler;

FIG. 8 illustrates bottom perspective view detail of an exemplary embodiment of the present invention eartip coupler;

FIG. 9 illustrates a exemplary dimensioned view of one potential preferred embodiment of the present invention eartip coupler;

FIG. 10 illustrates an exemplary method useful in some embodiments of the present invention.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a HEARING AID EARTIP COUPLER SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Form Factor Not Limitive

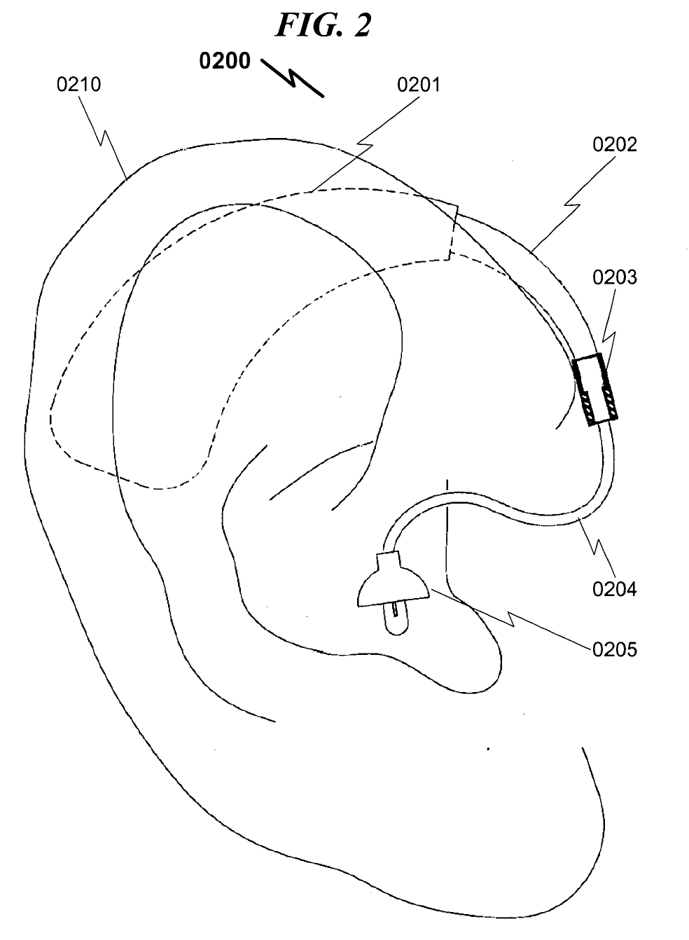

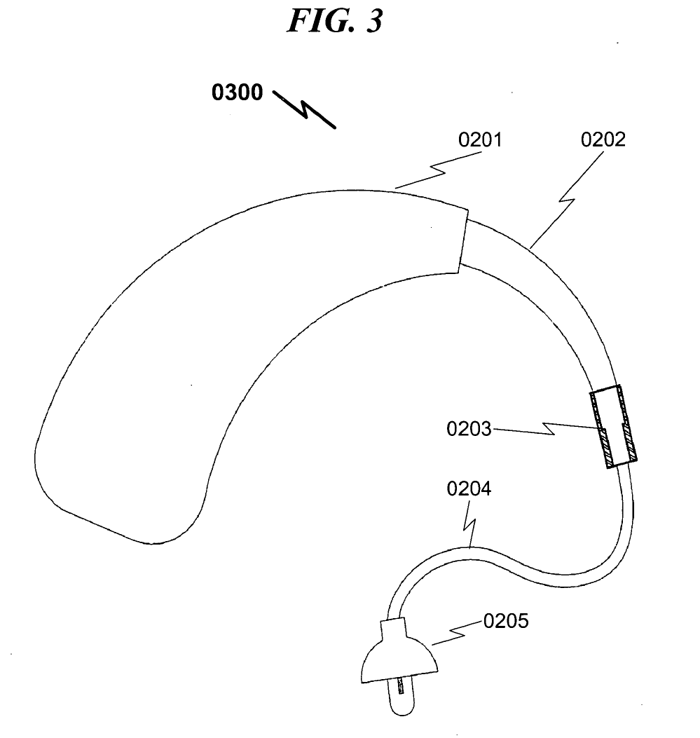

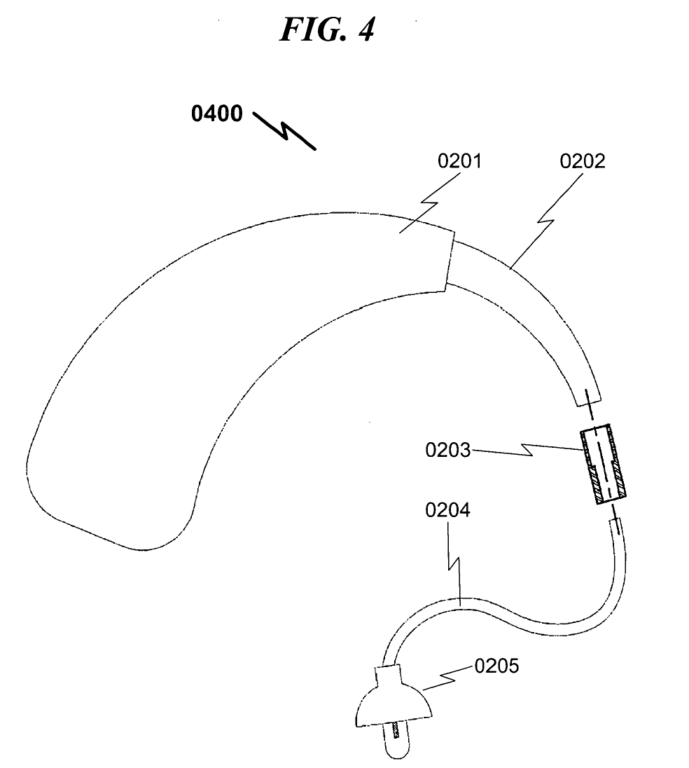

The present invention may be generally applied to situations in which a behind-the-ear hearing aid is to be coupled to a vented eartip connected to an eartip tube. While the preferred embodiments illustrated in FIGS. 2-9 indicate a cylindrical form factor for the hearing aid eartip coupler, one skilled in the art will recognize that that a wide variety of other form factors are possible which perform the same function as taught by the present invention.

### Exemplary System Components (0500,0600,0700,0800,0900)

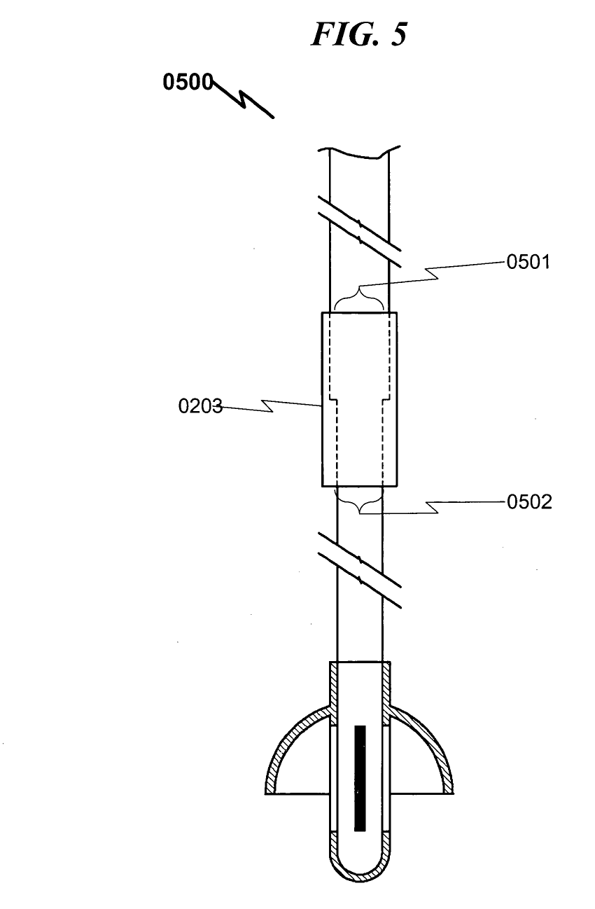

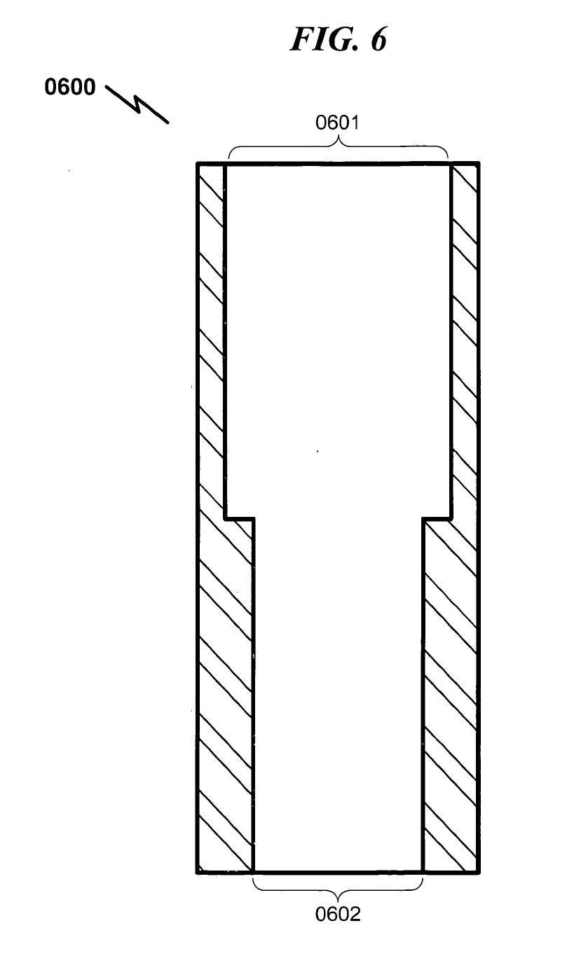

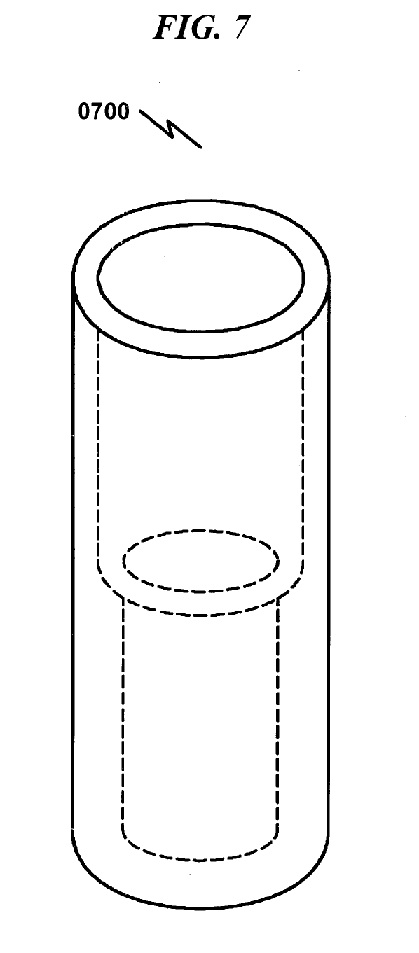

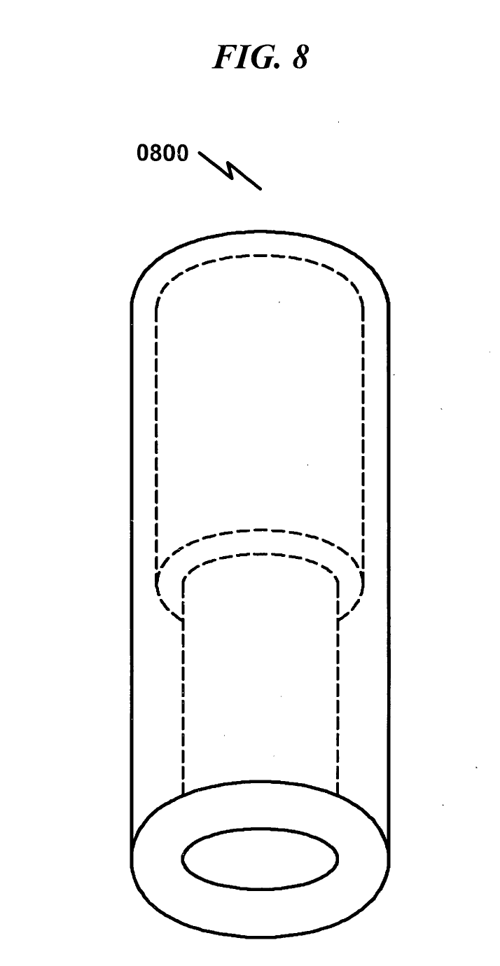

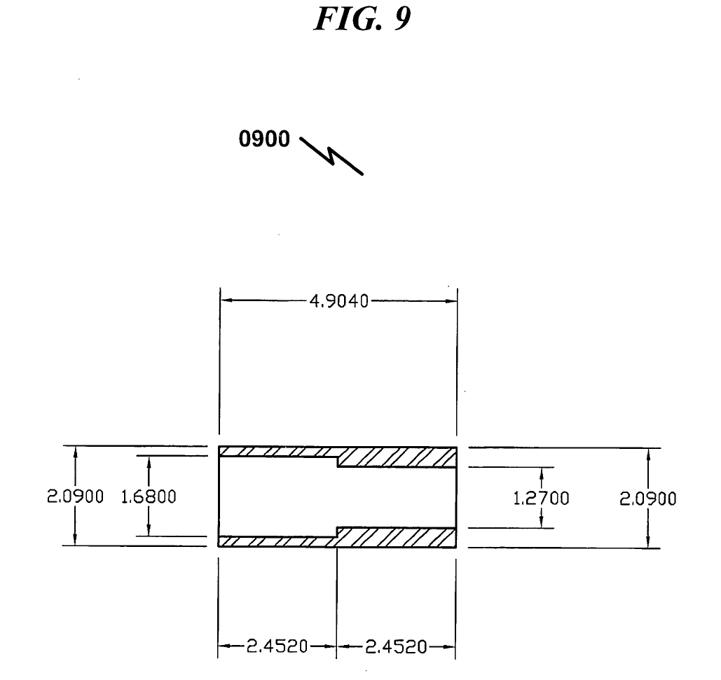

As illustrated generally in FIGS. 5-9 (0500, 0600, 0700, 0800, 0900), the present invention may be implemented utilizing a hearing aid eartip coupler that is generally cylindrical in shape, having internal cylinder diameters corresponding to the earhook interface diameter (0501) and the eartip tube diameter (0502) respectively. FIG. 5 illustrates a general assembly diagram using this exemplary eartip coupler (0203), with FIG. 6 illustrating a side detail view of the eartip coupler (0600), with top perspective view illustrated in FIG. 7 (0700), bottom perspective view illustrated in FIG. 8 (0800) and an exemplary dimensioned view illustrated in FIG. 9 (0900).

### Exemplary Dimensioned View (0900)

While the present invention may have a wide variety of dimensions, an exemplary dimensioned configuration is illustrated in the side view of FIG. 9 (0900) as an example of how the present invention may be applied to a particular earhook interface and eartip tube configuration. The dimensions illustrated in FIG. 9 are in millimeters (mm), and reflect a typical configuration only, but one skilled in the art will recognize that these dimensions can vary significantly based on a wide variety of earhook interface diameters and eartip tube diameters.

Note that the exemplary configuration in FIG. 9 (0900) illustrates how the eartip tube assembly can be configured with a small diameter eartip tube (approximately 1.2 mm outside diameter) mating to a much larger earhook interface (approximately 1.7 mm outside diameter) making this portion of the hearing aid system aesthetically pleasing to the patient. The present invention specifically anticipates embodiments wherein the eartip tube is approximately 1.2 mm in outside diameter. Additionally, the present invention specifically anticipates connection of the eartip coupler to an earhook interface with a diameter of approximately 1.7 mm, 2.0 mm, and 2.5 mm. In these situations, the present invention permits replacement of larger earmold tubes having outside diameters from approximately 2.5-3.5 mm.

### Exemplary Method Embodiment (1000)

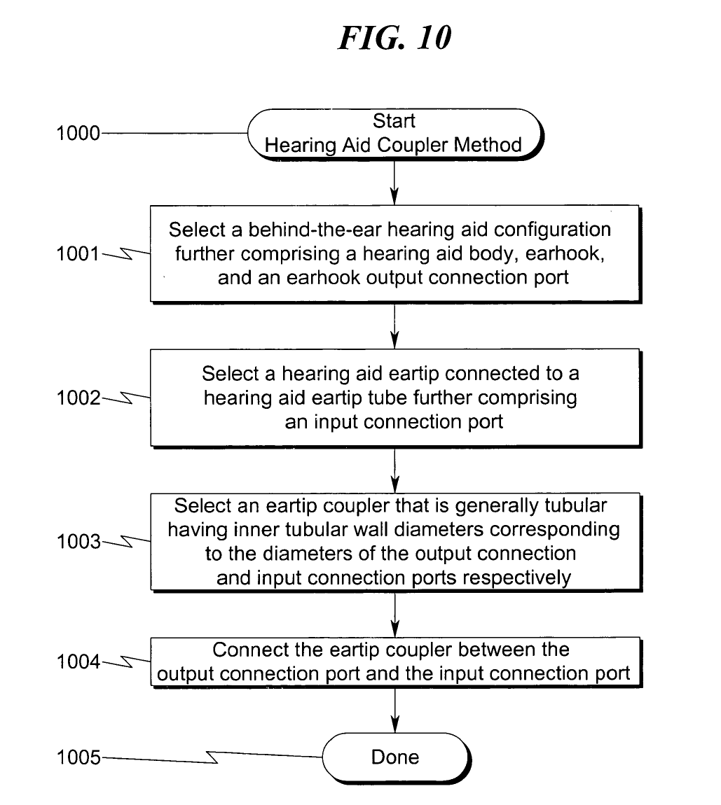

The present invention teaches a generalized hearing aid eartip coupler which is generally illustrated in FIG. 10 (1000) and includes the following steps:

(1) Selection of a behind-the-ear hearing aid configuration further comprising a hearing aid body, earhook, and an earhook output connection port (1001);

(2) Selection of a hearing aid eartip connected to a hearing aid eartip tube further comprising an input connection port (1002);

(3) Selection of an eartip coupler that is generally tubular having inner tubular wall diameters corresponding to the diameters of the output connection and input connection ports respectively (1003);

(4) Connecting the eartip coupler between the output connection port and the input connection port (1004).

At the end of this procedure, the behind-the-ear hearing aid has been retrofitted with a hearing aid eartip suitable for use with patients having mild to moderate hearing loss.

One skilled in the art will recognize that these steps may in some circumstances be rearranged with no loss of function with respect to application in the field of hearing aid coupler techniques.

### System/Method Applications

The present invention anticipates a wide variety of applications for both the disclosed system and method. These include but are not limited to the following:
The present invention is particularly well suited for situations in which existing behind-the-ear hearing aids are to be retrofitted with non-occluding eartips for use with patients having mild to moderate hearing loss.
The present invention is extremely useful in permitting patients having budget constraints to purchase and use effectively behind-the-ear hearing aids in conjunction with aesthetically pleasing eartip tubes and inexpensive hearing aids to achieve high performance hearing aid solutions.
The present invention permits use of small eartip tubes with existing behind-the-ear hearing aids, resulting in a more aesthetically pleasing hearing aid form factor.
   One skilled in the art will not doubt find other applications for the teachings of the present invention and its preferred embodiments.

### System Variations

The present invention anticipates a wide variety of variations in the basic theme of construction. The examples presented previously do not represent the entire scope of possible usages. They are meant to cite a few of the almost limitless possibilities.

A wide variety of materials may be suitable for the eartip coupler (0203), including a wide variety of plastics, thermoplastics, rubber, and the like. The critical aspects of the eartip coupler (0203) as illustrated in FIGS. 6-8 (0600, 0700, 0800) include cylindrical or tubular inner diameters that mate with the earhook interface (0601) and the eartip tube (0602) respectively.

Note that while the eartip coupler (0203) as illustrated in FIG. 5 (0500) is illustrated having a larger earhook interface diameter (0501) than the corresponding eartip tube interface diameter (0502), the reverse may be true as well, with the eartip tube diameter being larger than the earhook interface diameter. The present invention also anticipates the situation where the eartip coupler conforms to an earhook interface diameter and the eartip tube diameter that are substantially identical.

### Performance Comparisons

A significant motivation behind the present invention is application of inexpensive hearing aid technologies to the widespread need of 42% of the hearing impaired population with mild to moderate hearing loss. Many patients in this category may be opposed to using behind-the-ear hearing aid systems because of the unsightly nature of earmolds (0107) associated with these systems, despite the inexpensive nature of these systems (costing approximately USD$300). Alternatives to systems employing earmolds generally consist of high performance systems costing approximately USD$2000-USD$3000, which is beyond the financial means of many hearing impaired patients.

Laboratory studies performed by the inventor indicate that for many patients experiencing mild to moderate hearing loss there is no statistical difference in the performance of behind-the-ear hearing aid systems using the disclosed hearing aid coupler and expensive hearing aid systems currently on the market. Therefore, one motivation of the present invention is to exploit the functional equivalence of these systems in patient markets where a less expensive hearing aid solution incorporating an aesthetically pleasing eartip/eartube assembly is acceptable to the patient.

### CONCLUSION

A hearing aid eartip coupler system and method has been disclosed which permits interfacing existing hearing aids with a variety of high performance hearing aid eartips for use by patients with mild to moderate hearing loss. Conventional hearing aid earmolds connected to over-the-ear hearing aids suffer from a high degree of feedback and “tunnel effect” associated with blockage of the ear canal by the earmold, as well as unsightly large eartip tubes. The present invention permits cost-effective over-the-ear hearing aids to be retrofitted with a variety of vented hearing aid eartips and smaller eartip tubes to improve the performance and appearance of the overall hearing aid system for use with patients having mild to moderate hearing loss. Additionally, the use of the disclosed coupler system and method permits replacement and/or resizing of the hearing aid eartip should this portion of the system be deemed unsuitable for use by the patient.

Although a preferred embodiment of the present invention has been illustrated in the accompanying drawings and described in the foregoing Detailed Description, it will be understood that the invention is not limited to the embodiments disclosed, but is capable of numerous rearrangements, modifications, and substitutions without departing from the spirit of the invention as set forth and defined by the following claims.

What is claimed is:

1. A hearing aid eartip coupler system comprising:
(a) A behind-the-ear hearing aid further comprising a hearing aid body, earhook, and an earhook output connection port;
(b) A hearing aid eartip connected to a hearing aid eartip tube further comprising an input connection port;
(c) An eartip coupler connecting said output connection port and said input connection port;
wherein
said eartip coupler is generally tubular having inner tubular wall diameters identical to the outer diameters of said output connection and said input connection ports respectively.

2. The hearing aid eartip coupler system of claim 1 wherein said eartip coupler comprises plastic.

3. The hearing aid eartip coupler system of claim 1 wherein said hearing aid eartip is vented.

4. The hearing aid eartip coupler system of claim 1 wherein said output connection port has a larger diameter than said input connection port.

5. The hearing aid eartip coupler system of claim 1 wherein said output connection port has a smaller diameter than said input connection port.

6. The hearing aid eartip coupler system of claim 1 wherein said output connection port has a diameter substantially identical to said input connection port.

7. The hearing aid eartip coupler system of claim 1 wherein said input connection port has an outer diameter of approximately 1.2 mm.

8. The hearing aid eartip coupler system of claim 1 wherein said output connection port has an outer diameter of approximately 1.7 mm.

9. The hearing aid eartip coupler system of claim 1 wherein said output connection port has an outer diameter of approximately 2.0 mm.

10. The hearing aid eartip coupler system of claim 1 wherein said output connection port has an outer diameter of approximately 2.5 mm.

11. A hearing aid eartip coupler method comprising:
(1) Selecting a behind-the-ear hearing aid further comprising a hearing aid body, earhook, and an earhook output connection port;
(2) Selecting a hearing aid eartip connected to a hearing aid eartip tube further comprising an input connection port;
(3) Selecting an eartip coupler that is generally tubular having inner tubular wall diameters corresponding to the outer diameters of said output connection and said input connection ports respectively;
(4) Connecting said eartip coupler between said output connection port and said input connection port.

12. The hearing aid eartip coupler method of claim 11 wherein said eartip coupler comprises plastic.

13. The hearing aid eartip coupler method of claim 11 wherein said hearing aid eartip is vented.

14. The hearing aid eartip coupler method of claim 11 wherein said output connection port has a larger diameter than said input connection port.

15. The hearing aid eartip coupler method of claim 11 wherein said output connection port has a smaller diameter than said input connection port.

16. The hearing aid eartip coupler method of claim 11 wherein said output connection port has a diameter substantially identical to said input connection port.

17. The hearing aid eartip coupler method of claim 11 wherein said input connection port has an outer diameter of approximately 1.2 mm.

18. The hearing aid eartip coupler method of claim 11 wherein said output connection port has an outer diameter of approximately 1.7 mm.

19. The hearing aid eartip coupler method of claim 11 wherein said output connection port has an outer diameter of axpproximately 2.0 mm.

20. The hearing aid eartip coupler method of claim 11 wherein said output connection port has an outer diameter of approximately 2.5 mm.
